(19) United States
(12) Patent Application Publication
(10) Pub. No.: US 2016/0368593 A1
(43) Pub. Date: Dec. 22, 2016

(54) Cockpit seat armrest avionics cursor control device

(71) Applicant: Jeffrey C. Miller, San Diego, CA (US)

(72) Inventor: Jeffrey C. Miller, San Diego, CA (US)

(73) Assignee: Aerion Corporation

(21) Appl. No.: 14/545,771

(22) Filed: Jun. 18, 2015

(51) Int. Cl. B64C 13/04; B64D 11/06

(52) U.S. Cl. CPC B64C 13/04; B64D 11/0689; B64D 11/0644

(57) ABSTRACT

The invention concerns an improved CCD integration within pilot seat armrests, with benefits including ease and accuracy of CCD use, premium space savings on cockpit consoles, the ability to be retracted when not in use, always remaining within comfortable and easy reach of tall and short pilots alike and not interfering with other devices such as “side-stick” flight controls. The compactness and accuracy of use of the invention, its ability to be stowed, and its space-saving features set this CCD apart from existing CCDs and improve cockpit structure and pilot operation of aircraft that employ this invention.

### BACKGROUND OF THE INVENTION

This invention relates to the design of aircraft cockpit screen cursor control devices. Modern aircraft cockpits, so-called “glass cockpits,” incorporate large, flat-screen digital displays. The data displayed on the screens can be controlled, and interacted with, by pilots using various input methods, used singly or in combination. These include keyboards, touch screens, and devices that are somewhat analogous to desktop computer mice. These mouse-like pointing devices are referred to as cursor control devices.

Due to human factor requirements of having to interact with cockpit avionics while the aircraft is in motion, such as while maneuvering or bouncing while taxiing or while flying through turbulence, typical desktop computer input devices are often inappropriate. Cursor control devices (CCDs) are designed primarily for use in an unsteady environment. Current CCD designs are bulky, and consume premium space either on the center pedestal between pilot seats, or on the sidewalls, or side consoles, outboard of the pilot seats. Such locations also may cause potentially undesirable interference with the standard location of modern primary flight controls (“side-stick” controllers or inceptors).

Existing cursor control devices are typically either of the joystick type or grippable head type.

The joystick type CCD generally employs a stationary shaft, whose purpose is to steady the pilot's hand. At the free end of the shaft there is a control head with buttons, knobs, scroll wheels and other input controls. Typically, a pilot will hold onto the top of the shaft and use his fingers, usually the thumb and the forefinger, to interact with the input controls.

The grippable head type CCD consists of a stationary head typically attached to a flat surface in the cockpit, such as the center pedestal. The head portion of the CCD is used by the pilot to steady his hand. Buttons, knobs, track balls or other input controls are located about the hand to be finger engaged.

### SUMMARY OF THE INVENTION

The present invention concerns an avionics cursor control device that, unlike existing designs, simultaneously provides for excellent arm and hand support, carries controls configured and positioned for instant finger feel recognition of aircraft control function or functions, does not occupy space on the center pedestal or on the cockpit sidewalls or side consoles, and is within easy reach of each pilot without interfering with other cockpit controls, and is retractable for improved pilot ingress and egress. These position advantages are gained by integrating the CCD with the adjustable pilot seat armrest.

The seat armrest location follows the pilot's longitudinal and vertical seat adjustments and is therefore always in the ideal location for the comfortable placement of the arm and wrist. At the forward end of the armrest, arranged to be easily within reach of the pilot's fingers, with the wrist at a comfortable rest state, are the various input controls such as buttons, knobs, scroll wheels, joysticks, track balls, touch-sensitive or multi-touch surfaces. The armrest is preferably attached to the seat in such a way that it can be retracted or folded out of the way. A hinge may be employed at the aft end of the armrest to allow the armrest to be rotated upwardly to align parallel with and in the same geometric plane with the back of the seat.

A further important object is to provide a CCD positioned and manually used, as by controllably moving a fine-motor input for electronic flight control input into structure associated with a pilot's adjustable seat armrest.

Yet other objects include provision of devices as referred to herein at A- - -X.

These and other objects and advantages of the invention, as well as the details of an illustrative embodiment, will be more fully understood from the following specification and drawings, in which:

### DRAWING DESCRIPTION

FIG. 1 is an elevation view of a standard “glass” cockpit looking from rear to front;

FIG. 2 is a view showing the cockpit arrangement incorporating the present CCD invention;

FIG. 2a shows down positions of armrests and cursor devices;

FIG. 3 is a perspective view of a pilot seat with armrest CCD mounted on the right-hand side of the seat;

FIG. 4 is a close-up perspective view of an embodiment of the invention;

FIG. 5 is an elevation showing an armrest and hand rest, with spheroid type head, with button type controls;

FIGS. 6 and 8 show control buttons and other controls, on the head;

FIGS. 7 and 8 shows manual grasping of the head; and

FIG. 9 is a schematic showing control buttons.

### DETAILED DESCRIPTION

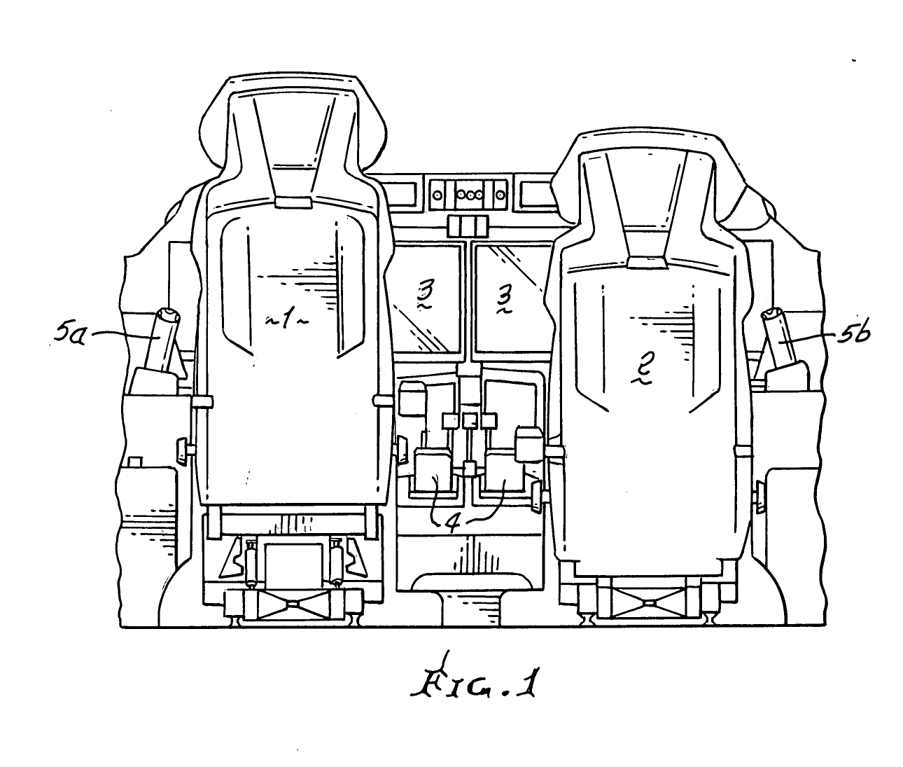

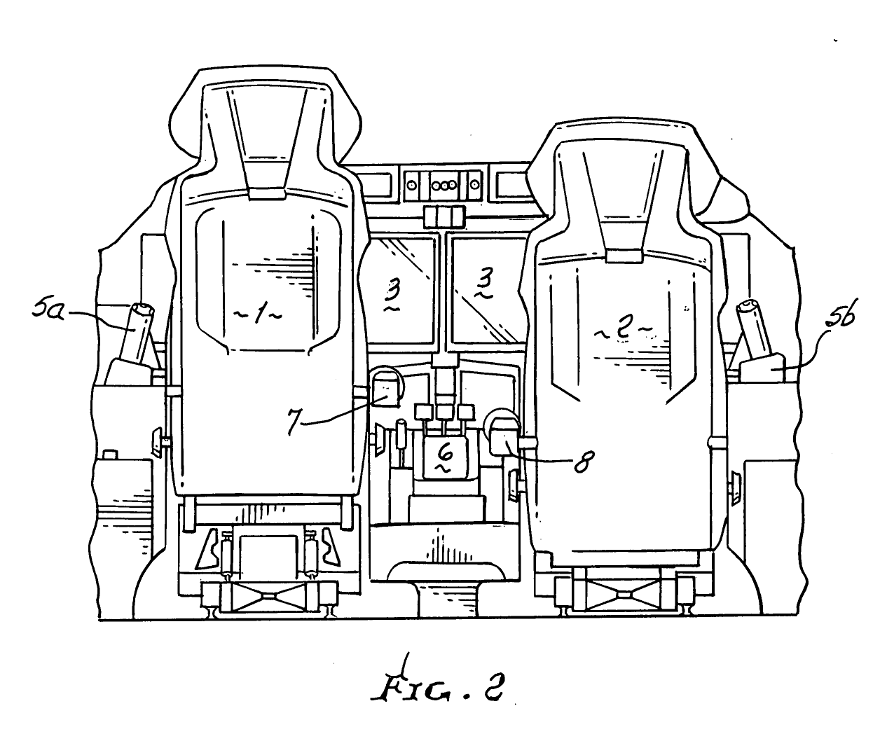

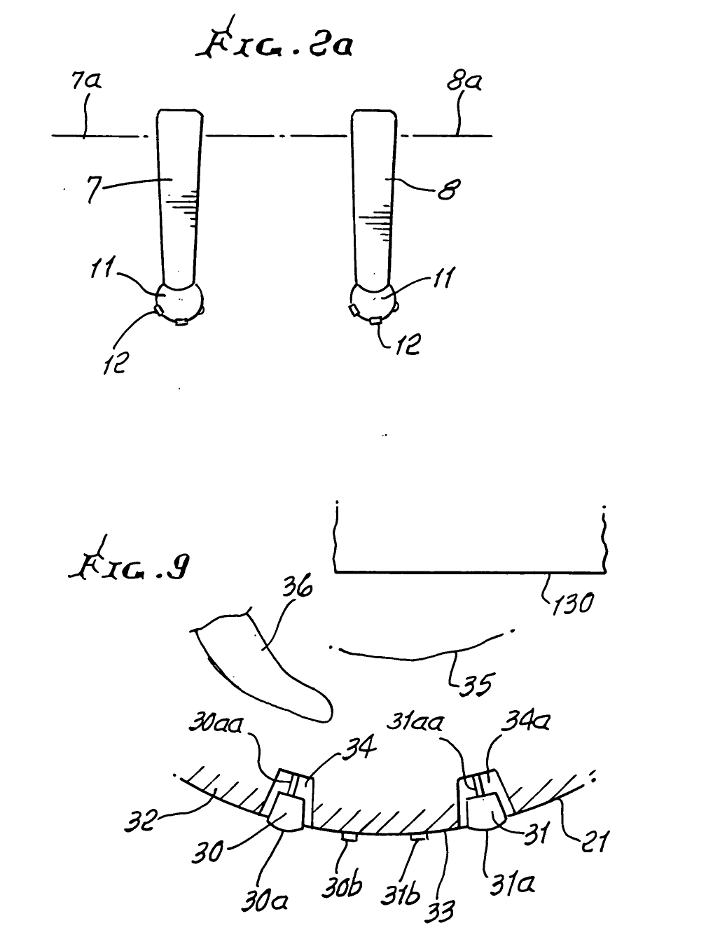

In FIG. 1 a standard “glass” cockpit is shown with pilot seat 1, copilot seat 2, flat screen displays 3, pedestal-mounted CCDs 4, and primary flight “side-stick” controllers 5a on the pilot's side and 5b on the copilot's side. FIG. 2 shows a modified cockpit arrangement that incorporates the invention. In this embodiment, a single pedestal-mounted CCD is shown 6 which is shared by the pilot and copilot when they do not wish to use the invention. It is also possible to replace all traditional CCDs with the invention. The invention permits a significant reduction in size of the central pedestal which is advantageous for pilot ingress and egress and also for space-limited cockpits. It can also be used to make space available on the pedestal for other avionics permitting improved cockpit layouts. For aircraft with side console-mounted CCDs, the invention can similarly save space by using an outboard seat armrest installation in place of the traditional CCDs. FIG. 2 also shows the pilot armrest 7 and copilot armrest 8 with seats adjusted for a short pilot and a tall copilot. FIG. 2a shows the armrests 7 and 8 pivoted downwardly about axes 7a & 8a. FIG. 3 shows the pilot seat from the front with armrest 22 and armrest-mounted CCD 9, and seat backrest 60. FIG. 4 is a close-up of the invention. The armrests are shown as is the CCD head 11 with representative buttons 12 and a two-direction 10a and 10b toggle switch or joystick 13. Other input controls such as scroll wheels, knobs, and touch-sensitive sensors can be installed on the CCD head. FIG. 2a schematically shows armrests 7 and 8 and control heads swung about axes 7a and 8a, to down positions.

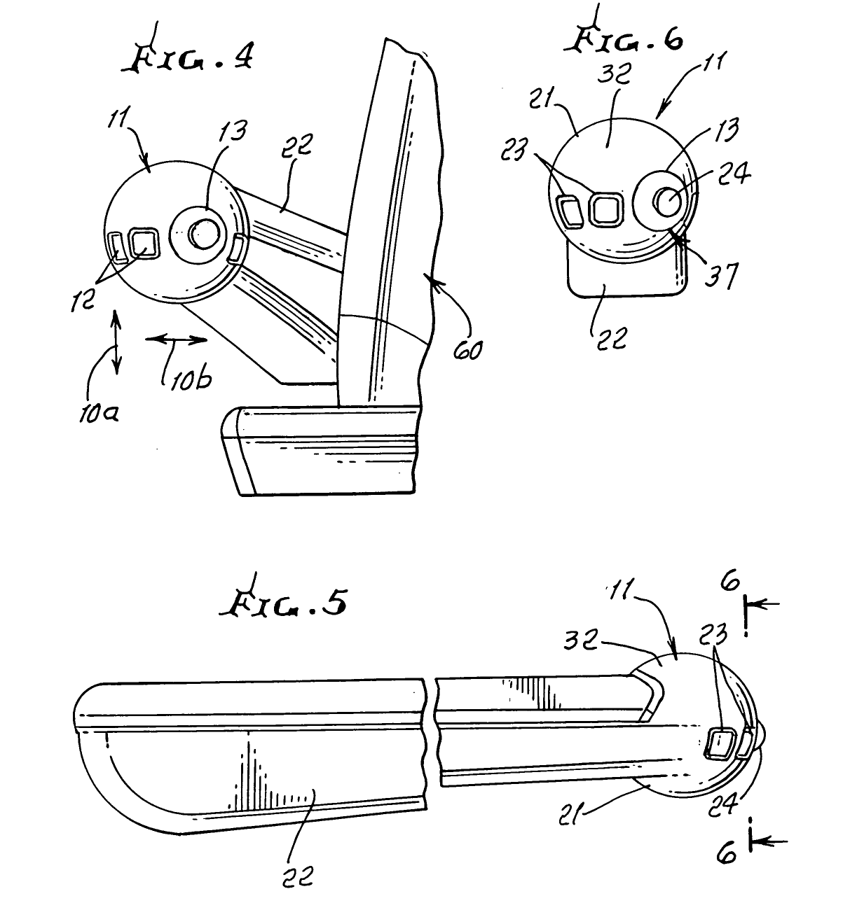

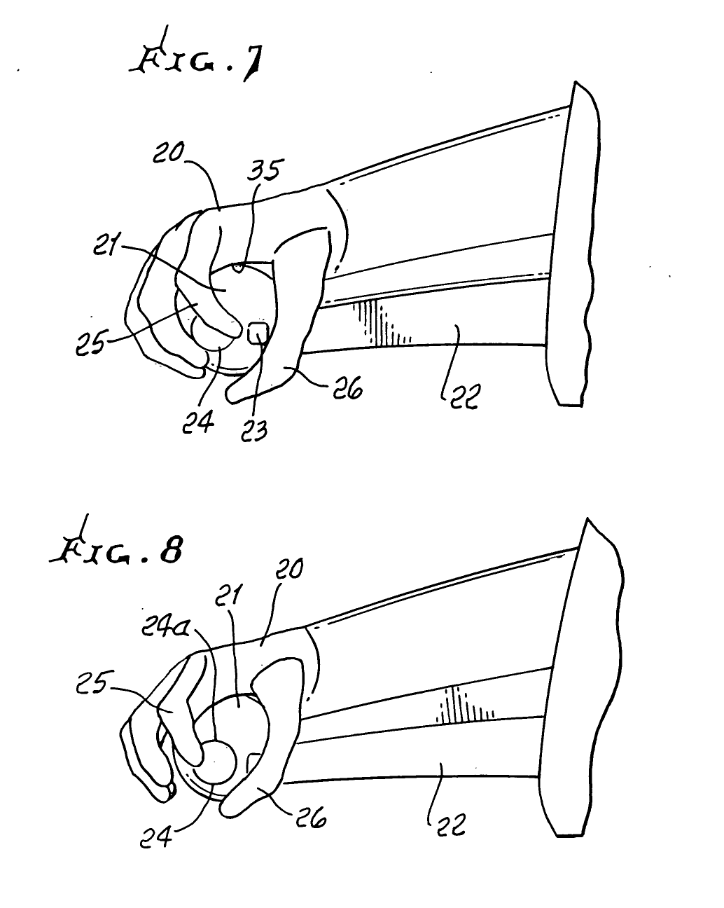

The surface shape of the CCD head can best be substantially overall spherical or outwardly substantially completely convex, as shown in the figures, for ease of hand 20 grasping as in FIG. 7. It may contain one local or more local flat surface, or may be locally elongated in one or more directions in order, for example, to improve ergonomics and hand steadiness for commanding inputs. See FIG. 7, showing the CCD head 21 which may also be flush mounted within or along armrest 22 such that it appears to be a standard armrest with one or more input control devices or sensors 23, 24 mounted in the vicinity of the locations where the fingers 25 and thumb 26 of the hand would normally rest, for example below the top ⅓ of the spheroid at the armrest forward end. FIG. 8 shows button 24 convex surface 24a substantially flush with head surface, and facing downwardly and forwardly.

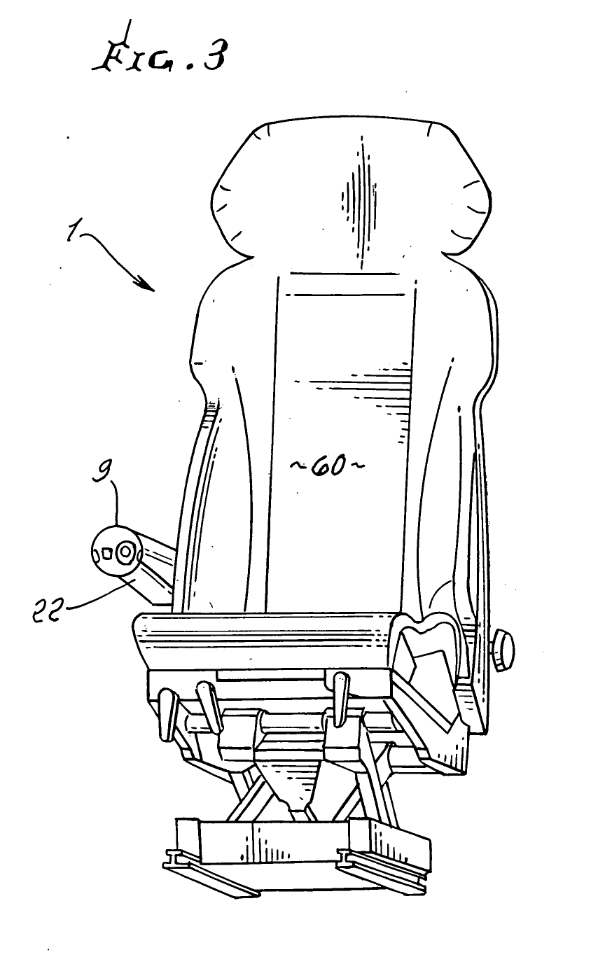

FIG. 9 also schematically shows control buttons 30 and 31 in recesses 34 and 34a in a head 32 having a downwardly convex surface 33, to be grasped by pilot's hand and fingers 36. See also FIGS. 5-7. The hand palm 35 generally conforms to the head surface, as shown, and buttons 30 and 31 have convex surfaces 30a and 31a to be selectively pushed in by the pilot's fingers. A button identification projection or projections 30b and 31b may be provided on the buttons or on the head, close to the buttons to provide instant finger feel identification of the particular button to be pushed. Joystick or click wheel structure is provided at 37 in FIG. 6. Head 32 is mounted at the forward end of the armrest. Button convex smooth surfaces project slightly from the recesses 34 and 34a as seen in FIG. 9. Also, the buttons 30 and 31 are shown as operatively connected at 30aa and 31aa to flight control circuitry indicated at 130.

It will be understood that the scope of the invention extends to, or is adapted to, the following, versions of which are described herein:

A. Devices wherein the armrest is a vehicle seat-mounted armrest which houses, at or near its end furthest from a seat backrest 60, finger operated control or controls to provide the vehicle operator with ease of interface with other vehicle systems.

B. Devices equipped with at least one input control mounted at or near the end of the armrest furthest from a seat backrest.

C. Devices located on the pilot's seat in a location other than that which is adjacent to a side-mounted primary control, and which is available for simultaneous use by an operator also manipulating primary controls with his or her opposite hand.

D. Devices having control button identification projections on or near to button surfaces to rapidly communicate button control functioning to user's finger or fingers.

E. Devices having mechanical elements to prevent inadvertent operation of controls.

F. Devices having software logic characterized in that positive action by the user is necessary to activate the controls, and wherein such action may be mechanically and/or electronically provided for and involve means for activating the controls such as an additional momentary switch which must be activated for example by simultaneous toggle, button/feature depression, push-pull slide engagement along the longitudinal axis of the armrest, or distinct pivot-and-lock active-use position.

G. Devices wherein device in-use conditions are not met at times when devices are not actively in use.

H. Devices having an inactive position, relative to seat-attachment mounting mechanism and structure of the armrest, characterized in that none of its associated input features will accept as commands any contact or manipulation of its controls.

I. Devices incorporating the subject armrest on either the left, right or both armrest position.

J. Devices employed on aircraft having one or more seats.

K. Devices wherein primary flight directional inputs to computers are controlled by manipulation of a side-stick inceptor, seat-centered inceptor, or seat-centered yoke/wheel.

L. Devices as referred to employed on aircraft.

M. Cursor control device adapted for aircraft pilot use in commanding pilot-input dependent aircraft systems, comprising: a pilot seat adjustable armrest, having a portion which is readily graspable by the hand of the pilot, a control or controls presented at said portion for ease of precise pilot command by means of provided easily actuated manual input, the armrest having physical and mechanical structure that enables the pilot to freely make full use of armrest utility, without concern for accidental engagement of said controls, and said control or controls having defined tactile cues to guide the pilot toward precise operation with minimal risk of erroneous input while providing for an eyes-forward experience in which the pilot need not look at the device, while pressing or activating the device.

N. Devices wherein said control or controls, readily and distinctly identifiable by touch, includes or include at least one of the following: button or buttons, knob or knobs, scroll wheel or scroll wheels, with or without the capability to depress the wheel as a means of making a selection, located for convenient operation by the thumb or index finger of the operator.

O. Devices wherein the armrest includes means for retraction and stowage.

P. Devices wherein said control or controls is or are at least partially recessed into, or otherwise at non-use times shielded, by armrest structure as provision against unintended manipulation of controls.

Q. Devices wherein there is distinct surface contouring of said portion, in at least the controlled in-use position and orientation, apart from other portions of said armrest in the vicinity of at least two of said controls with differently arranged tactile cues or means for controls identification without need for visual attention thereto.

R. Devices including means for armrest adjustment relative to the pilot's seat upon which it is attached.

S. Devices operable independently of seat adjustment means.

T. Devices wherein the device has a stored position to which it is movable relative to the seat upon which it is attached.

U. Devices wherein said position is characterized as out-of-the-way of pilot arm movement enabling pilot ingress to and egress from the seat.

V. Devices wherein each side position is substantially aligned with a plane defined by the rear face of the seat backrest.

W. Devices wherein visual cues and/or identifying markings are presented to view to confirm hand placement for and relative to known controls and specified functions.

X. Devices wherein distinct in-use control surface contouring is provided with respect to the controls, and identifies through visual and tactile cues that the device is in a ready position for use.

What is claimed is:

1. A seat armrest and associated finger operated controls to control and accurately interact with a vehicle operator's display system such as an avionics system, there being a hand and finger envelopable head at an end of the armrest as an armrest forward continuation, the controls having finger engagable surfaces proximate an outer and downwardly facing surface defined by the head.

2. The armrest of claim 1 with at least one input control mounted at the forward and downwardly facing end of the armrest.

3. The armrest of claim 1 having a pivoted stowed position when not in use.

4. A vehicle seat incorporating the armrest of claim 1 at either the left, right or both sides of the seat.

5. A vehicle comprising of one or more seats of claim 4.

6. The vehicle of claim 5 wherein the vehicle is an aircraft.

7. A cursor control device adapted for aircraft pilot use, comprising:
a) a pilot seat adjustable armrest, having a head portion graspable by the pilot's hand,
b) a control or controls presented at said portion, for ease of manual operation,
c) said control or controls having surface contouring, outwardly presented for finger engagement, there also being finger feel sensitive means at said head portion for providing accurate and rapid user's finger identification of individual controls as grasped.

8. The device of claim 7 wherein said control or controls includes or include at least one of the following:
i) button or buttons
ii) knob or knobs
iii) scroll wheel or wheels
iv) track ball
carried on a palm graspable spheroid surface on said head portion and including flight control circuitry to which said controls are operatively connected.

9. The device of claim 7 wherein the armrest includes retracting structure.

10. The device of claim 7, including a pilot's seat to which the device is attached to be adjustably moved relative to the seat.

11. The device of claim 7 wherein the device has a stored position to which it is movable, relative to the pilot's seat.

12. The device of claim 11 wherein said position is characterized as out-of-the-way of pilot's arm movement.

13. The device of claim 12 wherein said position is substantially aligned with a plane defined by the rear side of the pilot's seat.

14. The device of claim 7 wherein said control or controls is or are at least partly recessed into armrest structure,

15. The device of claim 7 wherein there are at least two of said controls with differently configured smooth surface contouring, providing different feel to the pilot's hand or fingers.

16. The device of claim 15 wherein said smooth surface contouring projects at least in part from head recess structure.

17. The device of claim 1 having control button identification projections on button surfaces to rapidly communicate button control functioning to user's finger or fingers.

18. The device of claim 1 wherein said armrest is vehicle seat-mounted armrest which houses, at or near its end furthest from a seat backrest, finger operated control or controls to provide the vehicle operator with ease of interface with other vehicle systems.

19. the device of claim 18 equipped with at least one input control mounted at or near the end of the armrest furthest from a seat backrest.

20. The device of claim 18 positioned on the seat in a location other than that which is adjacent to a side-mounted primary control inceptor, and which is available for simultaneous use by an operator also manipulating primary controls with his or her opposite hand.

21. The device of claim 18 having control button identification projections on button surfaces to rapidly communicate button control functioning to users finger or fingers.

22. The device of claim 18 having mechanical elements to prevent inadvertent operation of controls.

23. The device of claim 22 having software logic characterized in that positive action by the user is necessary to activate the controls, and wherein such actions may be mechanically and/or electronically provided for and involve means for activating the controls such as an additional momentary switch to be activated either by simultaneous toggle, button/feature depression, push-pull slide engagement along the longitudinal axis of the armrest, or distinct pivot-and-lock active-use position.

24. the device of claim 23 wherein the in-use conditions are disabled when the armrest is pivoted for storage.

25. The device of claim 22 wherein the device has an inactive position, relative to provided for seat-attachment mounting mechanism and structure of the armrest, characterized in that none of its associated input features will accept as commands any contact or manipulation of its controls.

26. An aircraft incorporating the armrest of claim 18 on either the left, right or both armrests.

27. An aircraft comprising of one or more seats of claim 26.

28. A cursor control device adapted for aircraft pilot use in commanding pilot-input dependent aircraft systems, including displays, comprising:
a) a pilot seat adjustable armrest, having a portion which is readily graspable by the hand of the pilot,
b) a control or controls presented at said portion for ease of precise pilot command by means of provided easily actuated manual input, without interference with movement of arm on armrest,
c) said armrest having physical and mechanical structure that enables the pilot to make full use of armrest utility, without concern for accidental engagement of said controls, and
d) said control or controls having defined tactile cues to guide the pilot, in precise operation of control or controls with minimal risk of erroneous input thereto, during viewing said display in which the pilot need not look at the control device.

29. The device of claim 28 wherein said control or controls, identifiable by touch, includes or include at least one of the following:
a) button or buttons,
b) knob or knobs,
c) scroll wheel or scroll wheels, with or without the capability to depress the wheel as a means of making a selection, located for convenient operation by the thumb or index finger of the operator,
d) track ball and/or finger operated 2-axis (4-direction) joystick, with or without the capability to depress the ball or stick as a means of making a selection, located for convenient operation by the thumb or finger of the operator.

30. The device of claim 28 wherein the armrest includes means for retraction and stowage.

31. The device of claim 28 wherein said control or controls is or are at least partially recessed into, or otherwise at non-use times shielded, by armrest structure as provision against unintended manipulation of controls.

32. The device of claim 28 wherein there is distinct surface contouring of said portion in at least the controls in-use position and orientation, in the vicinity of at least two of said controls with differently arranged tactile cues for controls identification without need for visual attention thereto.

33. The device of claim 28 including means for armrest adjustments relative to the seat upon which it is attached.

34. The device of claim 33 including seat adjustment means relative to the aircraft.

35. The device of claim 34 wherein the device has stored position to which it is movable relative to the seat upon which it is attached.

36. the device of claim 35 wherein said position is characterized as out-of-the-way of pilot ingress and egress from said seat.

37. The device of claim 36 wherein said position is substantially aligned with a plane defined by the rear face of the seat backrest.

38. The device of claim 37 wherein visual cues and/or identifying markings are presented to view to confirm hand placement for and relative to known controls and specified functions.

39. The device of claim 38 wherein distinct in-use surface contouring is provided with respect to said controls, and identifies through visual and tactile cues that the device is in a ready position for use.
